(19) United States
(12) Patent Application Publication
(10) Pub. No.: US 2009/0061222 A1
(43) Pub. Date: Mar. 5, 2009

(54) Multi-layer adhesive closure

(75) Inventor: Claus Grobe, Hamburg (DE)

Correspondence Address: NORRIS, MCLAUGHLIN & MARCUS, 875 THIRD AVE, 18TH FLOOR, NEW YORK, NY, 10022, US

(73) Assignee: Tesa Aktiengesellschaft, Hamburg (DE)

(21) Appl. No.: 11/867,099

(22) Filed: Oct. 4, 2007

(30) Foreign Application Priority Data
Aug. 31, 2007 (DE) 10 2007 041 474.0

(51) Int. Cl. B32B 7/12; B44F 1/12

(52) U.S. Cl. 428/343; 427/7

(57) ABSTRACT

The present invention relates to a multi-layer adhesive closure having a backing and an adhesive layer disposed over the full area beneath the backing, at least the following layers being disposed between backing and adhesive layer: a) a first layer applied not over the full area—marking layer; b) a second layer applied over the full area—contrast layer. It is proposed that an individual identifier be included for verification.

### BACKGROUND OF THE INVENTION

### Field of the Invention

The present invention relates to a multi-layer adhesive closure having a backing and an adhesive layer disposed over the full area beneath the backing. It includes layers disposed between backing and adhesive layer, a first layer applied not over the full area—marking layer and a second layer applied over the full area—contrast layer. The invention also relates to method of verifying the intactness of a package. For this end, the package is secured with a multi-layer adhesive closure, and the intactness of the adhesive closure is being checked,

The prior art has disclosed diverse multi-layer adhesive closures which provide opening detection for a package; in other words, which irreversibly indicate whether, in the case of a package secured by means of an adhesive closure of this kind, a first attempt at opening has already taken place. Detection of this kind is vital in a logistics chain, in order to ensure that the package in question, a parcel or pallet for example, has not been opened at some point without authorization.

An adhesive closure of this kind is shown by, for example, DE 100 30 596 A1, in the form of a multi-layer adhesive tape. The adhesive closure first has a backing based on an oriented thermoplastic film, a primer layer having been applied to the bottom face of said film, but not over the full area, and being anchored to the thermoplastic film. The primer layer and the free surface of the thermoplastic film are covered over the full area with a first, more particularly coloured contrast layer. This first contrast layer is anchored more effectively to the primer layer than to the thermoplastic film. In the product described in DE 100 30 596 A1 the first contrast layer is covered over the full area in turn with a second contrast layer, which is anchored better to the first contrast layer than the first contrast layer is to the thermoplastic film. The second contrast layer is followed by a pressure-sensitive adhesive, which is anchored better to the second contrast layer than the first contrast layer is to the thermoplastic film.

When a prior-art adhesive closure of this kind is opened for the first time, as a function of the anchoring of the respective layers to one another, a rupture is produced at the point where the anchoring between two layers is at its weakest. Between which layers this rupture occurs is dependent on whether the region in question bears primer or not. The primer layer applied on the full area has been applied beforehand in the form of an indicium, such as “opened”, for example, to the backing, so that this text now appears and indicates the first-time opening. Even when the layers are stuck to one another again, the indicium remains in evidence.

A further prior-art adhesive closure is shown by DE 101 40 491 A1, in the form of a multi-layer label. In the case of the label described therein as well the detection of first-time opening is realized by means of a functional layer sequence.

One disadvantage of an adhesive closure of this kind, however, is that the adhesive closure can be removed fully from the object to be secured and can where appropriate be replaced by a new closure. Any new adhesive closure may in turn be an adhesive closure which includes first-time opening detection, but may also be an adhesive closure which is merely of similar appearance, without this kind of first-time opening detection. In the context of the logistics chain, manipulation of this kind becomes apparent only at the end of the logistics process, in other words, in general, by the end customer. It is therefore no longer possible to ascertain where such manipulation has taken place, in order to discover those responsible.

### SUMMARY OF THE INVENTION

The problem the present invention solves is utilizing a multi-layer adhesive closure which makes manipulation within the logistics chain more difficult.

The invention solves the above-mentioned problem associated with a multi-layer adhesive closure. Here, a multi-layer adhesive closure has a backing and an adhesive layer disposed over the full area beneath the backing, at least the following layers being disposed between backing and adhesive layer: a) a first layer applied not over the full area—marking layer; b) a second layer applied over the full area—contrast layer and an individual identifier is included for verification. Further, Method of verifying the intactness of a package is provided in which the package being secured with a multi-layer adhesive closure, which is checked with respect to the intactness of the adhesive closure by verified its authenticity.

The solution to the problem is achieved in accordance with the invention by the multi-layer adhesive closure including not only the first-time opening detection but also an individual identifier for verification. Throughout the logistics process, therefore, it is possible to check whether the closure is still the original adhesive closure or whether it has been switched at some point. Consequently, in tandem with the first-time opening detection, manipulation of the secured article itself, such as a package, for example, is also impossible. This individual identifier may include, for example, individual information such as origin, manufacturer, type, distribution channel and/or serial number of the object to be secured or of the adhesive closure itself. More particularly the identifier may take the form of an alphanumeric symbol, barcode (1-dimensional), matrix code (2-dimensional) or the like. Where very high security is to be ensured, it is also possible for individually calculated, computer-generated holograms to be included as identifiers. With regard to the configuration of computer-generated holograms of this kind, reference is made more particularly to EP 1 377 883 B1.

The identifier can be applied to the backing or any other layer of the adhesive closure. Provision may also be made for the identifier to be disposed within a layer. An embodiment of that kind is advantageous, for example, for the introduction of a computer-generated hologram. Such a hologram may be written, for example, into the backing or into another layer, where appropriate an additionally provided storage layer, by means of a laser lithograph. Particularly advantageous, however, is the application of the identifier between two other layers, as for example between the backing and the contrast layer, in other words adjacent to the marking layer applied not over the full area. A disposition of this kind has the advantage that the identifier can be disposed in a concealed and possibly even hidden manner, so making it more difficult to copy.

In the case of the adhesive closure of the invention, and in the manner known from the prior art (DE 101 40 491 A1), the first-time opening detection may take the form, in its simplest embodiment, of a first layer, not applied over the full area, on the backing, i.e. the marking layer, and of a second layer which covers the full area of the marking layer and the free surface of the backing, i.e. the contrast layer. In this case the backing may be formed as an oriented thermoplastic film made from oriented HDPE, PVC, PET, monoaxially oriented polypropylene or biaxially oriented polypropylene, and more particularly may be transparent. In a preferred embodiment, the marking layer is an adhesion promoter or a primer. This layer is anchored very well to the backing. The contrast layer, on the other hand, is anchored better to the marking layer (primer) than to the backing. Provided beneath the contrast layer, moreover, is the adhesive layer, which takes the form, for example, of a pressure-sensitive adhesive applied over the full area. The adhesive layer, in turn, is anchored better to the contrast layer than the contrast layer is to the backing.

An alternative embodiment of the first-time opening detection consists, for example, in designing the marking layer as a partial release layer. A person skilled in the art will also be aware of other methods and embodiments for the partial setting of the adhesive properties of the various texts, these properties being necessary for first-time opening detection. More particularly reference is made in this context to EP 341 699 B1, U.S. Pat. No. 5,153,042, U.S. Pat. No. 5,582,887 and U.S. Pat. No. 5,633,058, whose disclosure content is incorporated by reference.

In a first inventive embodiment, when the adhesive closure of the invention is removed from the surface of a package, it leaves a marker on the package, by virtue of the fact that the contrast layer, which more particularly is a coloured contrast layer, undergoes separation from the backing, whereas regions which are well anchored by the marking layer (primer) to the surface of the backing are detached with the backing from the surface of the package. The region of the contrast layer which was strongly anchored against the surface of the backing by means of the marking layer remains on the surface of the backing. The marker apparent on the package therefore shows the inverse image of the non-full-area marking layer. Where the marking layer has been applied as an indicium or other kind of marker, therefore, the inverse of this marker becomes visible.

In a second inventive embodiment, when the adhesive closure of the invention is removed from the surface of a package, it leaves a marker on the package, by virtue of the fact that the contrast layer, which more particularly is a coloured contrast layer, remains on the backing and is detached together with it from the package, while regions which are not anchored or not strongly anchored to the backing surface by means of the marking layer (release) undergo attachment from the backing and remain on the surface of the package. The region of the contrast layer which has not been anchored, or has been anchored only weakly, to the surface of the backing by means of the marking layer remains on the package. The marker evident on the package therefore shows the image of the non-full-area marking layer. Where the marking layer has been applied as an indicium or other kind of marker, therefore, this marker becomes visible.

Besides the marking layer and the contrast layer it is also possible for other layers to have been provided, more particularly further contrast layers. For the embodiment in this respect, reference is made to the prior art. More particularly the disclosure content of DE 100 30 596 A1 is incorporated for this purpose by reference.

In a preferred embodiment the identifier is configured as a machine-readable identifier. This offers the advantage that, within the logistics chain, in an automatic sorting procedure, for example, the adhesive closure can be verified automatically. Manual and hence labour-intensive checking can be avoided as a result. Depending on the embodiment of the identifier, however, manual verification may also take place in addition or alternatively to automatic verification. In particular, such verification may also be envisaged additionally or alternatively by the eventual recipient of the adhesive closure.

In a particularly preferred embodiment the configuration of the multi-layer adhesive closure is such that the identifier is not visible without auxiliary means and/or with the naked eye. In this case the identifier in particular is in a concealed disposition and can be found and read only using suitable auxiliary means. The hidden disposition of an identifier can be produced, for example, by applying it with a fluorescent dye, so that it is not visible under daylight (white light). Instead, a specific light source, in this case UV light, is needed in order to be able to read the identifier. In a preferred version the marking layer comprises a fluorescent dye of this kind. In this case it is possible by way of the fluorescence to check at least whether the multi-layer adhesive closure includes a corresponding first-time opening detection. If the first-time opening detection is also individualized and hence forms the individual identifier, the adhesive closure can be fully verified as well.

In a preferred embodiment a part at least of the identifier is encoded. Encoding makes it possible to ensure that valid identifiers cannot be generated arbitrarily. Instead, by means of subsequent verification of the encoding, it can also be ensured that the identifier is an authentic identifier or a copy. An embodiment of this kind is especially advantageous when verification takes place centrally, since it is possible thus to ensure that the key for encoding and decoding cannot be used without authorization. The central verification may take place, for example, by way of modern communication pathways, such as a connection between detection units and the central control, or by mobile telephony, etc.

A key which is kept secret within the encoding and decoding process allows the encoding or decoding operation to be performed for an algorithm which is known per se and is not kept secret. For the purposes of this invention, symmetrical and asymmetrical algorithms can be employed. In accordance with the invention it is particularly preferred to use symmetrical algorithms, such as, more particularly, AES, 3DES, and DES. Algorithms of this kind are already being utilized at present extensively within the fields of financial transactions, the encryption of electronic communications, and in the field of wireless communications technology.

Verifying an encoded identifier is particularly simple especially when the identifier includes not only the encoded part but also an unencoded part which is coupled to the encoded part. With the aid of the key, which must be kept secret, either the encrypted part is decrypted and compared with the unencoded part of the identifier, or, alternatively, the unencoded part is encrypted and the result is compared with the encoded part of the identifier. The second, alternative method is the preferred one. It allows the encoded part of the identifier to be shortened and hence, taking into account the security requirement, allows the data volume or the overall length of the identifier on the adhesive closure to be reduced. A similar principle is known, for example, from digital signatures.

As well as the key, the interim outcome of the verification within an encryption process of this kind is also kept secret from the user and from other, external access, this outcome being the result, then, of the encoding or decoding. By way of a communication pathway, possibly a public communication pathway, the user is informed only of the outcome of the comparison, in the form of a yes/no answer. Otherwise a generator of valid identifiers would be made available.

In the way known in principle from the prior art, the multi-layer adhesive closure can be designed as a security label or else as an adhesive tape. If it takes the form of an adhesive tape, a plurality of individual identifiers should be provided on the adhesive tape. More particularly these identifiers should be disposed in regular spacings, in order to allow the adhesive tape to be used in any length.

In the case of a method of the invention, the intactness of a package is verified. This means that it is ascertained whether a manipulation has been performed on a package. For this purpose it is determined first of all whether the package, and the adhesive closure securing the package, are intact. The check here, therefore, is in particular as to whether the adhesive closure is indicating first-time opening. Furthermore, the adhesive closure itself is checked with regard to its authenticity. In other words a determination is made of whether an original adhesive closure is disposed on the package, or whether a manipulation has been performed with respect to the adhesive closure. Only when both tests have been successfully concluded is the intactness of the package verified. The sequence of the individual testing steps in this method is not critical. It is, however, appropriate first to check the adhesive closure for intactness, since this check can be carried out more quickly and easily, generally speaking, than the verification of the adhesive closure.

To verify the adhesive closure its individual identifier is read and checked. The checking may take place, for example, by matching with a reference value. The reference value may be stored, for example, in a database, or else may be present in the adhesive closure itself. This is especially appropriate when at least part of the identifier is encoded. Where, moreover, the encoded part and the unencoded part are coupled with one another, verification may take place by decryption of the encoded part or, preferably, by encryption of the unencoded part and matching of the two parts of the identifier.

The verification of the identifier, and more particularly the encryption or decryption of an encoded identifier and the comparison of the two parts, preferably take place centrally in a method of this kind, in order to minimize the degree of dissemination of reference values and/or decryption codes. The verification query can be made by means for example of modern mobile communication services, via the internet, by mobile telephone or the like.

In particular there may also be provision for an additional identifier to be read, which provides information on whether the adhesive closure, thus in particular an adhesive closure which has not yet been opened, includes first-time opening detection. An identifier of this kind and/or, depending on the configuration of the adhesive closure, the individual identifier as well are/is read from the marking layer.

In a preferred embodiment the verification of the intactness of the package can be carried out automatically. In this case an automatic check is made that no first-time opening has taken place. In particular this also involves a check as to whether the object secured with a multi-layer adhesive closure has been secured with an original adhesive closure. This requires the object to be secured to be equipped with a multi-layer adhesive closure, of the type described above, which in particular includes a machine-readable identifier. If the identifier is encoded, then, in particular, automatic encryption/decryption of the identifier and comparison of the identifier with a reference value are carried out. This reference value, as has been described above, may likewise be read from the multi-layer adhesive closure. Alternatively the reference value can also be stored in the system. If a deviation is found from the specified values in the course of the automatic verification, in other words, for example, first-time opening has already been indicated or a non-original adhesive closure is found, then, in a preferred embodiment of the method, a corresponding signal is produced. This signal may be produced, for example, acoustically or visually, through labelling of the object in question. Alternatively or as a supplement to this, the object in question is preferably extracted directly.

### BRIEF DESCRIPTION OF THE DRAWINGS

In the drawings, wherein like reference numerals delineate similar elements throughout the several views:

FIG. 1 shows a three-dimensional depiction of a package to which the adhesive closure of the invention has been adhered,

FIG. 2 shows a sectional drawing of the adhesive closure of the invention, in its original, bonded form,

FIG. 3 shows a sectional drawing similar to FIG. 3, but showing the relationships between the individual layers when the adhesive closure is removed from the box for the first time, and

FIG. 4 shows an enlarged extract of the depiction in FIG. 1, with an adhered adhesive closure partially detached from the package surface.

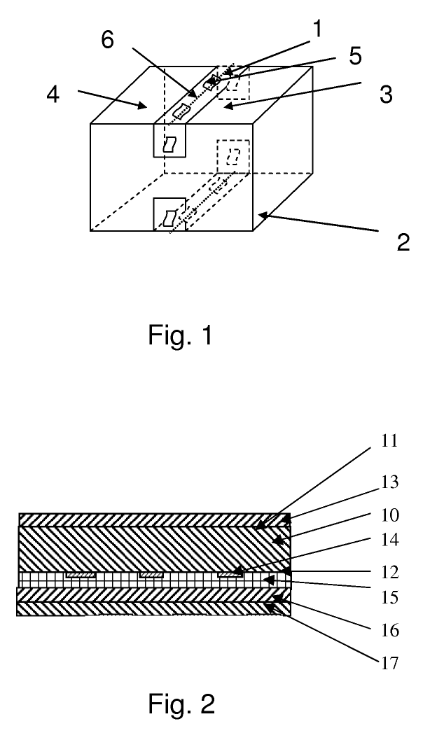

### DETAILED DESCRIPTION OF THE PRESENTLY PREFERRED EMBODIMENTS

The preferred embodiment of the invention is depicted as adhesive tape 1, which is used for the closing and securing a box or a package 2. The box or package 2 has upper lid flaps 3 and 4, which for the closing of the package 2 are folded down and meet at a line 6. In the usual way, the adhesive tape 1 is bonded on the top and bottom face of the package 2 across the line 6, and is adhered to the end faces of the package 2, in order to hold down the lid flaps 3 and 4 to close the package.

In order to gain access to the contents of the package 2 without drawing subsequent attention to the attempted opening, the adhesive tape 1 must be removed along line 6 for folding the lid flaps 3 and 4 up. If the adhesive tape 1 used on packages or boxes is a standard commercial adhesive tape, it is impossible, following removal of the contents from the package 2 and careful rebonding of the adhesive tape 1, to perceive that the adhesive tape 1 has been detached once already at an earlier stage. However, even if a prior-art adhesive tape with opening detection is used, there is a risk of this tape being fully detached from the package 2 and the package 2 being subsequently bonded using a new adhesive tape.

The present multi-layer adhesive closure, shown here in an embodiment as adhesive tape 1, therefore additionally has an individual identifier 5, which identifies the adhesive closure and also verifies its proper closing. Unnoticed opening and re-closing of the package 2 therefore have as little chance of success as unnoticed opening and subsequent switching of the adhesive tape. An individual identifier 5 is provided a number of times on the tape, with spacing between each occurrence. In particular these identifiers 5 can be provided in regular spacings. The two or more individual identifiers 5 are in each such case configured differently from one another, which makes it more difficult to counterfeit a valid identifier.

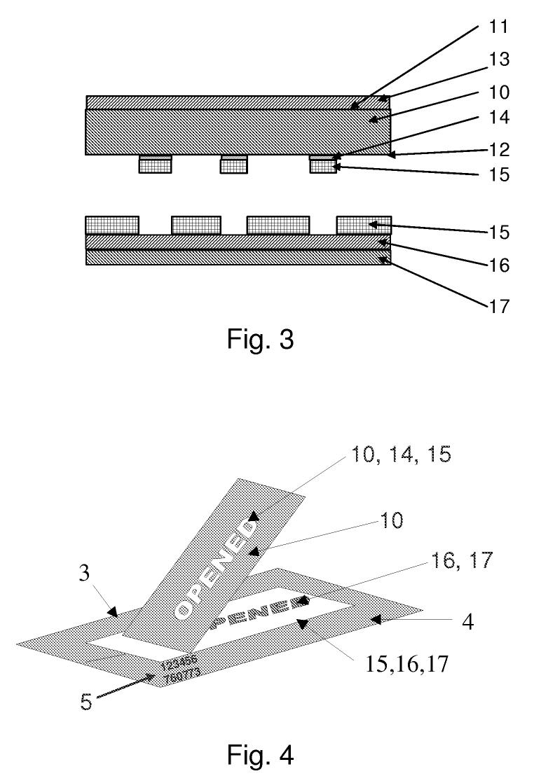

FIGS. 2 and 3 show the structure of the adhesive tape 1 with the function of detection of opening. It will be appreciated, however, that signals other than the signal shown can also be employed. The adhesive tape 1 has a preferably transparent thermoplastic film as its backing 10. The design of the backing is such that it has sufficient internal strength, satisfying the requirements in respect of first-time opening detection.

In a first operation, a non-full-area (or intermittent) transparent primer layer is applied as marking layer 14 to the lower surface 12 of the backing 10. The disposition of the marking layer 14 on the backing surface 12 is such that it produces an indicium which, if the adhesive tape 1 is detached from the package 2, can be perceived on said package.

In a second step a first contrast layer 15 is applied over the full area to the marking layer 14 and the remaining backing surface 12. In this case, and preferably, the contrast layer 15 is composed of a coloured material. In a third step a further contrast layer 16 is applied over the full area to the contrast layer 15. The contrast layer 16 is composed of a coloured or colourless material. The colour and colour density of the layers 15 and 16 are selected such that they present a sufficient colour contrast to the typical package material colours. For other kinds and other colours of container, however, it is also possible to use other colours adapted accordingly. The next step is to apply an adhesive layer 17 to the contrast layer 16, this layer 16 ensuring sufficiently reliable bonding on the package surface.

In accordance with this example, the adhesion of the marking layer 14 to the backing surface 12 is relatively strong. The adhesion of the contrast layer 15 to the backing surface 12 is relatively weak, but it adheres relatively strongly to the marking layer 14. The adhesion of the contrast layer 15 to the backing surface 12 is lower than the adhesion of the contrast layer 16 to the adhesive layer 17. The adhesion of the contrast layer 1 5 to the contrast layer 1 6 is higher than the adhesion of the marking layer 14 to the backing surface 12.

Applied to the top face 11 of the film backing 10 is a preferably transparent release layer 13, which adheres relatively strongly to the surface 11. The adhesion of the release layer 13 to the adhesive layer 17 is low, thereby allowing an adhesive tape 1 wound into a roll to be unwound without release of the contrast layer 15 from the film surface 12.

When the adhesive tape 1 in the structure according to FIG. 2 has been bonded to a surface, the uniform colour of the colour layers 15 and 16 is visible as a result of the preferred transparency of the release layer 13 and of the film backing 10, and also of the marking layer 14.

When the adhesive tape 1—as shown in FIG. 4—is detached from the package surface 3, 4, the adhesive tape 1 separates in accordance with FIG. 3. The contrast layer 15, together with the contrast layer 16 and the adhesive layer 17, separates off from the backing 10 in the region at which the contrast layer 15 is in direct contact with the backing surface 12, and it remains on the package surface 3, 4. In the region where there is the marking layer 14, the contrast layer 15 separates from the contrast layer 16. The adhesive layer 17 remains with the contrast layer 16 on the package surface 3, 4, and the contrast layer 15 remains on the backing film 10. The word “OPENED” is visible as an indicium on the package surface 3, 4, and as a coloured indicium on the backing 10.

When the detached portion of the adhesive tape 1 is replaced, the indicium “OPENED” remains visible, since at the boundary between contrast layer 15 and contrast layer 16 the layer of air produces an alteration in refraction as compared with the previous structure without an air layer. Furthermore, owing to the fact that the backing 10 has deformed during application and detachment, the indicium on the backing film 10 can no longer be inserted congruently into the exposed indicium on the package surface.

From FIG. 4 it is apparent that the individual identifier 5 is disposed at a distance from the indicium of the first-time opening detection. In this case the identifier 5 has been applied adjacent to the partially applied marking layer 14 between the backing 10 and the contrast layer 12. This identifier may have been applied with a special ink, a fluorescent ink for example, and hence may be legible only under defined light conditions (UV light). In this case, however, the identifier has been applied in such a way that it is visible even without auxiliary means. The visibility is ensured in particular not least as a result of the transparency of the backing 10.

The marking layer 14 itself may be designed as an individual identifier 5. If the marking layer 14, moreover, comprises a fluorescent dye, the individual identifier 5 can be read under suitable light conditions without destruction of the adhesive closure. Alternatively provision may also be made for the marking layer 14 to include an additional identifier to the individual identifier 5. By means of this additional identifier it is then possible in any case to ascertain whether the adhesive closure comprises the first-time opening detection. This additional identifier can likewise be achieved by means of a fluorescent dye in the marking layer 14.

Furthermore, the identifier may take the form of a machine-readable identifier. Depending on the case in hand, provision may also be made for the individual identifier 5 to be exclusively machine-readable, i.e. legible exclusively with suitable technical auxiliary means. This is the case particularly when the identifier is designed as a bar code or as a computer-generated hologram.

The individual identifier 5 shown in detail in FIG. 4 is composed in the present case of two parts. The first part contains the alphanumeric number sequence “13456”. This part of the identifier is unencoded and corresponds, for example, to a serial number. The second part of the identifier 5 contains the alphanumeric number sequence “760773”. This number sequence is an encoded number sequence. Before the identifier 5 is made in the adhesive closure, the second part of the identifier 5 was calculated in the present case from the first part of the identifier 5, hence in this case the serial number, by means of an encryption code. The two parts of the identifier 5 are therefore coupled in terms of their content, in the present case, indeed, containing the same information, once in encoded form and once in unencoded form. Hence, in order to verify the adhesive closure, both parts of the code can be read and, following decryption of the second part of the identifier 5, can be compared with one another. Since, however, the code for encryption and decryption is not general knowledge, it is virtually impossible for counterfeiters to generate their own valid codes. Moreover, the security can be increased still further by using each identifier 5 once only and storing it in a database. Following verification, this identifier 5 can then be stored as invalid for the future, so that further utilization of this identifier 5 on a new adhesive closure can be identified as counterfeit.

The adhesive closure of the invention is suitable for use as a security closure for clearly evidencing an unauthorized attempt at opening, or opening, for a large number of valuable and/or sensitive goods. One important field of use in this context is the securement of a wide variety of consumer goods against theft, falsification of the contents, and protection against pirate copies. The unnoticed opening, theft and falsification of sensitive goods is prevented by the use of the adhesive tapes of the invention.

Owing to the ready internal separation of the adhesive closures of the invention over their full area when the adhesive closure is removed, they are particularly suitable for the anti-opening securement or packaging of easily splitable paper packaging and/or the packaging of kraftliner packages, but are not restricted to these utilities.

The adhesive closures of the invention are suitable for a large number of adhesive tape applications. One important field of application is that of packaging applications. The adhesive closures are suitable for use as package sealing tapes, general adhesive packaging tapes, strapping tapes, adhesive tapes for sealing plastic packaging and plastic bags, and for securing pallets. Further applications are the bundling of loose goods and goods in transit, such as pipes, wooden strips etc. The adhesive closures of the invention may be used to secure refrigerators, for example, and other electrical and electronic appliances in transit. Further applications are in label protection, surface protection, in the construction segment, for example, and as tear-open strips for packaging. Applications in the office segment are likewise possible.

Further possible applications include the packaging of medical and pharmaceutical products, the securement of packaging containing cosmetics and body care articles, and of foodstuffs and luxury consumables, as a security closure. The securement of electronic and electrical appliances is another possible application.

1. A multi-layer adhesive closure comprising
a backing having a top surface and a bottom surface
a marking layer being disposed intermittently to the bottom surface of the backing,
a first contrast layer being disposed below the marking layer,
an adhesive lawyer extending over the backing,
a first identifier being disposed between the backing and the adhesive layer.

2. The multi-layer adhesive closure according to claim 1, wherein the first identifier is machine-readable.

3. The multi-layer adhesive closure according to claim 1, wherein the marking layer is disposed above the first contrast layer.

4. The multi-layer adhesive closure according to claim 1, wherein the marking layer comprises a fluorescent dye.

5. The multi-layer adhesive closure according to claim 1, wherein the marking layer comprises an second identifier.

6. The multi-layer adhesive closure according to claim 5, wherein the individual identifier and second identifier are invisible without auxiliary means and/or with the naked eye.

7. The multi-layer adhesive closure according to claim 1, wherein the identifier is machine-readable.

8. The multi-layer adhesive closure according to claim 1, wherein at least part of the first identifier is encoded.

9. The multi-layer adhesive closure according to claim 1, wherein the first identifier comprises a one-dimensional barcode.

10. The multi-layer adhesive closure according to claim 1, wherein the identifier comprises a hologram.

11. The multi-layer adhesive closure according to claim 1, wherein the closure is a security label.

12. The multi-layer adhesive closure according to claim 1, wherein the closure is an adhesive tape.

13. The multi-layer adhesive closure according to claim 12, wherein the adhesive closure has a plurality of individual identifiers, spaced apart in regular intervals.

14. The multi-layer adhesive closure according to claim 1, wherein the first identifier comprises a two-dimensional matrix code.

15. The multi-layer adhesive closure according to claim 10, wherein the hologram is a computer-generated hologram.

16. A method of verifying the intactness of a closure of a package, providing a multi-layer adhesive closure, comprising
a backing having a top surface and a bottom surface
a marking layer being disposed intermittently to the bottom surface of the backing,
a first contrast layer being disposed below the marking layer,
an adhesive lawyer extending over the backing,
a first identifier being disposed between the backing and the adhesive layer,
securing the package with said multi-layer adhesive closure,
checking the intactness of the adhesive tape,
verifying the adhesive closure of its authenticity.

17. The method according to claim 16, wherein the first identifier is read and verified.

18. The method according to claim 17, wherein for verification the first identifier is decrypted and/or compared with a reference value.

19. The method according to claim 18, wherein the first identifier and the reference value is read from the adhesive closure.

20. The method according to claim 16, wherein the first identifier is read from the marking layer.

21. The method according to claim 16, wherein the verification of the adhesive tape takes place automatedly, more particularly in that, in the case of an unauthentic adhesive tape, a signal occurs and/or the package in question is extracted.

22. The method according to claim 19, wherein, in the case of an unauthentic adhesive tape, a signal occurs and/or the package in question is extracted.
